(19) United States
(12) Patent Application Publication
(10) Pub. No.: US 2009/0024690 A1
(43) Pub. Date: Jan. 22, 2009

(54) METHOD AND SYSTEM FOR ACCESSING ON-LINE CONTENT ACCORDING TO SIMPLE CODE OF OFF-LINE CONTENT

(76) Inventor: Hee Han, Seoul (KR)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/162,431

(22) PCT Filed: Jan. 29, 2007
(86) PCT No.: PCT/KR07/00496

§ 371 Date: Jul. 28, 2008

(30) Foreign Application Priority Data
Jan. 27, 2006 (KR) 10-2006-0009150

(51) Int. Cl. G06F 15/16

(52) U.S. Cl. 709/202

(57) ABSTRACT

The present invention relates to a system for and method of matching off- and on-line media content. Users of off-line content are easily able to access on-line content with this content-matching system. The system includes: 1. A Content Provider Server, which is a device in which simple code information of off-line content is stored, and with which the simple code of offline content is linked with a URL of the online content. 2. A User Terminal, which is a device with which users input the simple code for acquiring the online content. 3. An Intermediating Service System, which is a device for supplying the online content corresponding to the simple code and the URL.

### TECHNICAL FIELD

This present invention relates to a system for and method of matching off- and on-line media content. The present invention further relates to a system and method of off- and on-line content linking services which provide off-line print media content with simple code with corresponding on-line content.

### RELATED ART

Various methods have been developed in order to call out on-line content using computers. Content are located in a sub directory of a web site (e.g., World Wide Web). URLs of the content can be made by hyper-link on the Internet. The tree-structured content, typically named as Chungwadae, is able to be called by clicking a URL on a web browser. The linking hyper-link can call the related content by a simply click of the content title. On the other hand, in order to access on-line content, the user should use a domain name or URL which is included in off-line media content.

FIG. 1 is a systematic diagram for directly calling out on-line content corresponding to off-line content, by using a URL. According to FIG. 1, print media, such as books (10), use representative names (11), for example, book title, author, publisher, in order to classify and distinguish content. Picture content is classified as picture 1, picture 2, and context content is classified as sentence or chapter. Additional online content (20) is printed as domain names or URLs (13). In FIG. 1, item 40 represents the internet. However, the deeper the depth of the online content is, the harder it is for users to write on or read the media. Korean patent 10-2005-0030711 is a method of printing URL bar code (13) on the web, reading the code with a camera or a bar code reader, and linking the content.

FIG. 2, is a systematic diagram for recognizing a bar-code type URL by using cell phones. The camera in a cellular phone reads the URL, which is printed in bar code type and links with on-line content though the Internet. However, under this method, as the number of bar codes is increased, the printing shape gets distorted and it might cause repeated photographing. In addition, installing a bar code reader in the mobile phone causes cost increase.

### SUMMARY

Accordingly, the present invention substantially obviates a difficulty for accessing on-line content based on a printed information. The objective of this creative model is to supply an interoperable system using simple code between on-line and off-line content, as the solution for the problems mentioned above, while existing off-line printable media such as book, connect with on-line content with URLs. If the location of the additional content is easily traced and directly callable one to one, only refined content are recorded in papers, and additional information is provided through on-line content linked with printed content, such as movies, pictures or music. Furthermore, selling clothes or goods advertised in magazine through on-line is possible.

To achieve these advantages and in accordance with the purpose of the present invention provided is a system for and method of matching off- and on-line media content. Users of off-line content are easily able to access on-line content with this content-matching system. The system provides:

1. a Content Provider Server is a device in which simple code information of offline content is stored, and with which the simple code of offline content is linked with the URL of the online content.

2. a User Terminal is a device with which users input the simple code for acquiring the online content.

3. an Intermediating Service System is a device for supplying the online content corresponding to the simple code and the URL. This invention is designed to match the URL with the content code on the Internet. The method used in here overcomes the limitations of paper in terms of space and costs, and minimizes additional costs that can be created by naturally integrating with the online content space.

### DESCRIPTION OF DRAWINGS

FIG. 1 is a schematic diagram of directly calling out on-line content corresponding to off-line content, by using a URL.

FIG. 2 is a schematic diagram for recognizing a bar-code type URL by using cell phones with a built-in camera.

FIG. 3 is a schematic diagram for accessing on-line content by simple code of off-line content.

FIG. 4 is an example of providing print media with simple code.

FIG. 5 is an example of providing print media with simple code.

FIG. 6 is an example of providing newspaper with simple code.

FIG. 7 is a schematic diagram of an off-line and on-line content linking service.

FIG. 8 is a flow chart of an off-line and on-line content linking service.

FIG. 9 is a schematic diagram for providing an off-line and on-line content linking service using a cell phone.

FIG. 10 is a flow chart for providing an off-line and on-line content linking service using a personal computer.

FIG. 11 is a schematic diagram for providing off-line and on-line content linking service using a terminal dedicated to the service and remote control.

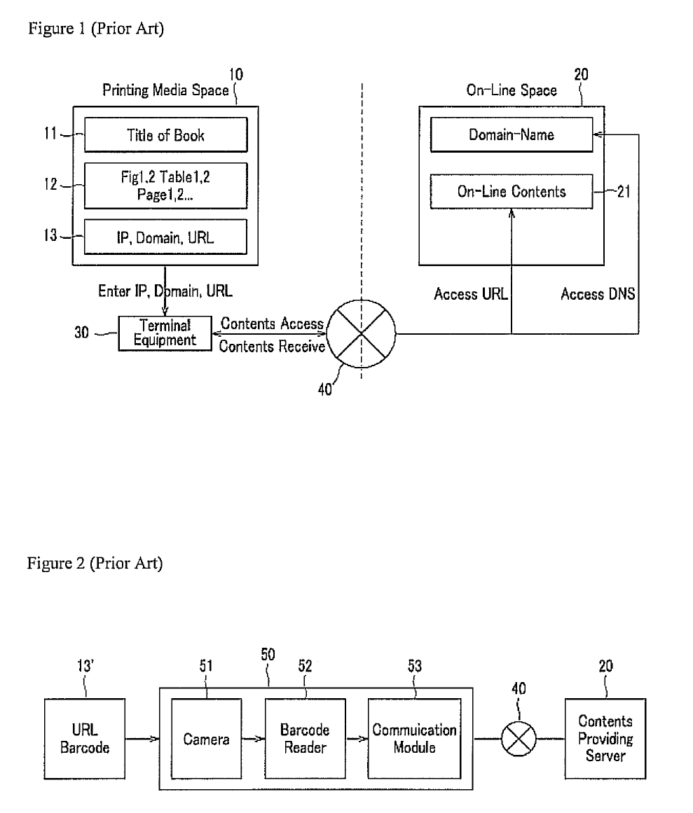

### REFERENCE NUMERALS

| | |
|---|---|
| 100 Off-line Media | 110 Simple Code |
| 120 User Terminal | 130 On-line Content Providing Server |
| 210 Content URL | 140 Intermediation system |

### DETAILED DESCRIPTION OF PREFERRED EMBODIMENTS

Hereinafter, preferred embodiments of the present invention will be described in detail with reference to accompanying drawings.

For achieving the purpose, the method of this invention is characterized in the following steps, (in the making of off-line content, after making on-line content correspond to the content of off-line media, in off-line content matching service that an off-line content user can easily access). The steps are as follows: a step, in which the URL is granted, so that the provider can easily access on-line content via the internet,

a step that the content provider registers with an intermediating service system by matching the simple code of off-line content to the URL of on-line content, a step that off-line content user enters the simple code into the intermediating service system, a step that intermediating system provides a user terminal with a URL which corresponds to the simple code inputted, a step that user terminal accesses on-line content using the URL.

For achieving the purpose, the system of this invention features the following components (in the making of off-line content, after making on-line content correspond to the content of off-line media, in off-line content matching service that off-line content user can easily access,) the content provider server that performs registration by matching the simple code of off-line content to the URL of on-line content; after granting a simple code to the content of off-line media for accessing on-line content correspond to the content of off-line media and a URL to easily access on-line content via internet. The user terminal that user enters the sample code for acquiring on-line content corresponds to off-line content after buying a off-line media from content provider. The intermediating service system which helps the user terminal to acquire applicable on-line content, after simple code is entered in the user terminal and provides user terminal with the URL which corresponds to the simple code inputted. Refer to the figures for examples.

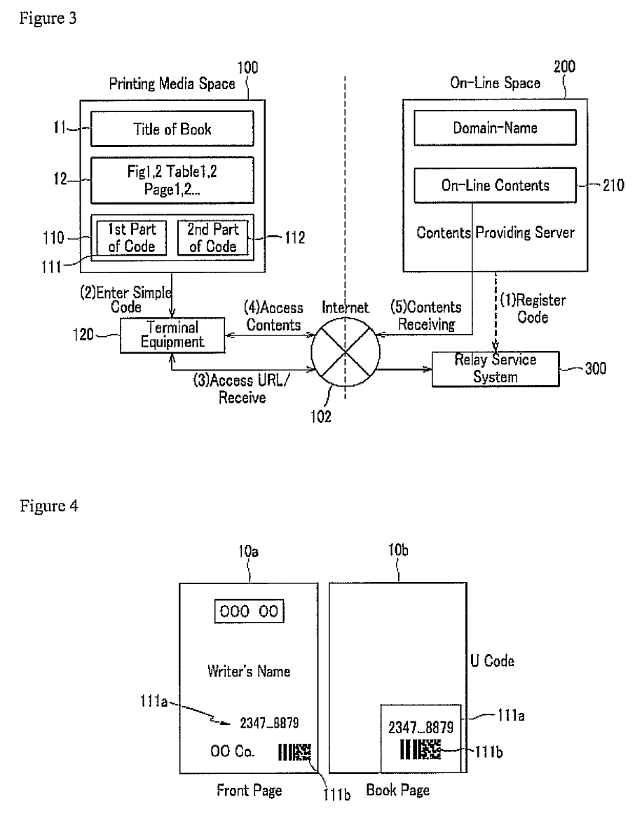

In this creative model, user can use some code (“simple code”) in off-line content for linding between off-line content (content in off-line printable media) and on-line content (multimedia content in anon-line server). The simple code must be translated into a reliable URL through the server for intermediated service. Below examples are classified in three 1a patterns. A method of assigning the simple code from paper media corresponding to the URL. A method of inter-operable service using simple code translating URL, between on- and off-line content. A method of using in mobile terminals, for inter-operable service between off- and on-line content.

[1] The Method of assigning the simple code of paper media corresponding to the URL. FIG. 3 calls out content using the simple code.

Generally, the paper media, book and magazine, use a representative title included for the content, Content includes the chapter and sentence. If these books correspond to a Website, then the title of book is the domain name and the number of figures and pages are the dedicated URLs. Content Provider makes the online content before the paper media is distributed, and registers some URL to an intermediate service system (300) corresponding to the simple code (110).

An Intermediate Service System is shown as [table 1]. The Intermediate Service System consists of a database which maps the simple code of the paper media and corresponds with the online content URL.

TABLE I

| Simple Code | | URL |
|---|---|---|
| 1 code | 2 code | URL |
| U001 | UU0002 | http://www.kipo.net/patent/change/kkk1.html |
| U001 | UU0002 | http://www.kipo.net/patent/change/kkk2.html |
| U001 | UU003 | http://www.kipo.net/patent/change/kkk3.html |

To call out additional on-line content, an off-line media subscriber puts simple (2) code in use terminal (120) instead of using a complicated URL. Intermediating service system (300) searches the simple code received through user terminal (120) in a database mapping table, translates it into a corresponding URL, and informs (3) the user terminal (120). Finally, the user terminal (120) accesses the on-line content through the URL (4). According to this invention, the user can access on-line content by a simple code without typing a URL.

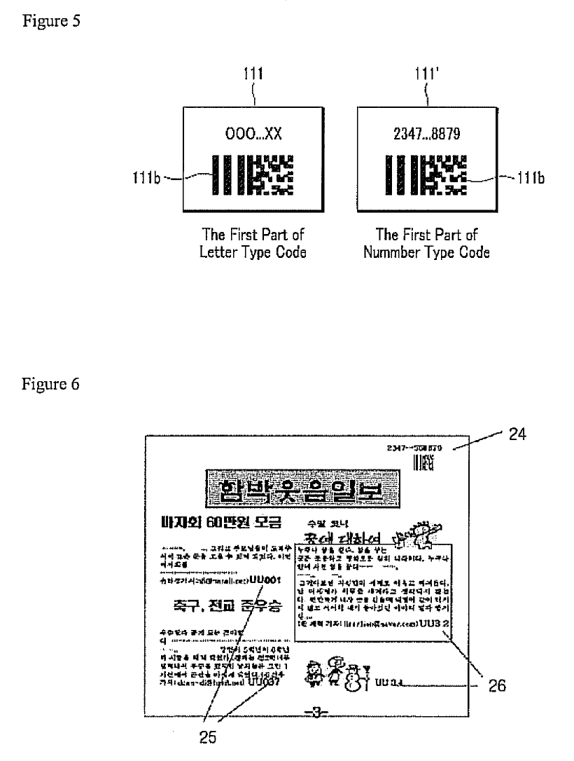

When inputting the simple code to the content written in the off-line publications, there are two ways to do so. First, imposing the 1^{st} code by pinpointing the whole content in the off-line publication. Second, imposing the 2^{nd} code to each content written inside the relevant content. The 1^{st} code and the 2^{nd} code can be defined differently depending on the characteristics of the publication. FIG. 4 is an example of applying the 1^{st} code to the cover of a book. FIG. 5 is an example of printing the simple code into a bar code, letters and numbers. FIG. 6 is an example of applying the simple code to a newspaper.

When applying the simple code, write down the 1^{st} code in the first and the last page of a book. For die content of a book, impose the 2^{nd} code. The 1^{st} code represents the title, author and the publisher of a book, but sometimes letters or numbers can be used in discriminating a publication. Also, the 1^{st} code can be read by a camera installed in a cell phone or a bar code reader. Sometimes, it can be printed with the bar code (see FIG. 5). The 1^{st} code represents each content inside a book. In other words, the 1^{st} code is used for the title and the 2^{nd} code is used for the content in a book. Therefore, input a simple code by using the 1^{st} code and then input the 2^{nd} code for content. When the 1^{st} code is made as a bar code, the code can be used with a bar code reader or a camera installed in a mobile phone. Also, when we use a PC, input the 1^{st} code and then the 2^{nd} code without inputting the URL. The 2^{nd} code can be used without harming the nature of a book. This method is helpful for the book producers in providing additional content through the Internet. Users can get the service interfaced to the Internet while reading books.

However, each newspaper company is providing short movies, which are used as supplementary materials to support the news articles, by collecting the short movies from each company's website. However, users cannot recognize whether they get the additional content by mainly reading the news on the Internet or not. And although users know the fact, it is a complicated process as users should visit every website of newspaper companies.

If this method is applied to a newspaper, as seen from the FIG. 6, print the 1^{st} code on the upper or the lower side of a newspaper. Also, print the 2^{nd} code, then users can input the simple code (the 1^{st} and the 2^{nd} code) in the relay service system, and see the short movie. The 1^{st} code (which is frequently used by users) is already inputted, so the user can mainly call the relevant content through the 2^{nd} code. In particular, if content are provided consecutively, users can move to other content by mainly moving the cursor and the mouse up and down.

When the simple code is applied to a variety of magazines and books, additional content on the Internet can be directly connected to the content of a book, and through a user terminal unit, the limitation as being a paper can be overcome. In other words, it is easy to provide multimedia content by integrating the online with the offline.

Furthermore, diverse methods including the imposition of the 2^{nd} code are possible. For example, serial numbers depending on the order of additional content in the book, the 2^{nd} code can be applied. The page of a book can use the 2^{nd} code. When diverse content exists on the same page, a page for discrimination can be added and the 2^{nd} code can be applied. Also, certain signals, numbers and letters can be applied, or existing marking can be maintained, or additional codes can be used in the front or in the back of a book.

[2] Transform the URL into offline-online content,

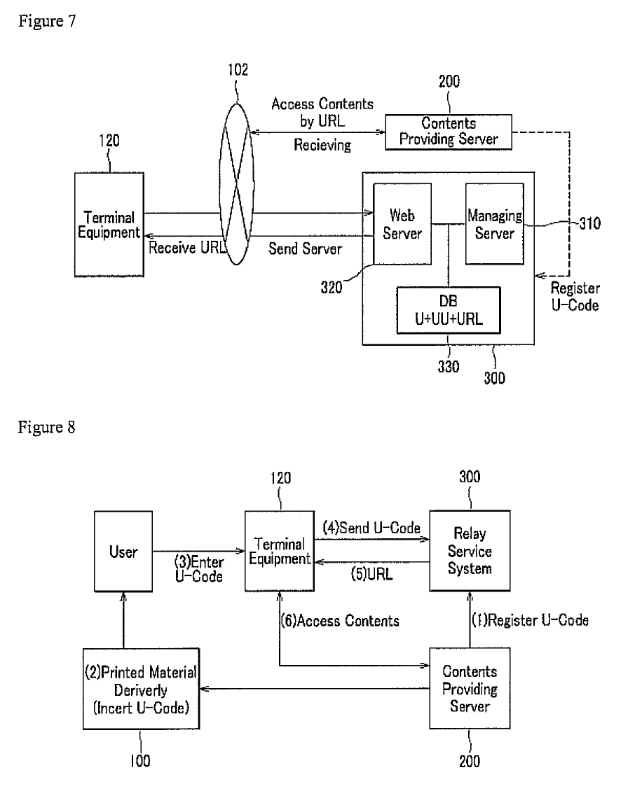

FIG. 7 is a diagram explaining the interfacing service of offline and online content, and FIG. 8 is a diagram explaining the interfacing process of offline and online content. A relay service system used for offline-online content interfacing service is composed of a management server, a web server and a database, Content provider stores the URL and the corresponding simple code into a database through the management server. If the user terminal equipment sends a simple code to the web server by internet, the relay service system transforms the simple code to a corresponding URL using the database and sends the URL to the user terminal equipment. Then, the user terminal equipment can access content from a content provider server.

In the case of the interfacing process of offline and online content, the private person or the company (content providers) can register the simple code in the relay service system. In this case, the simple code can be the URL. The relay service system can store the simple code and the URL in the database. The private person or the company (content providers) can input the simple code and do the publication and distribution.

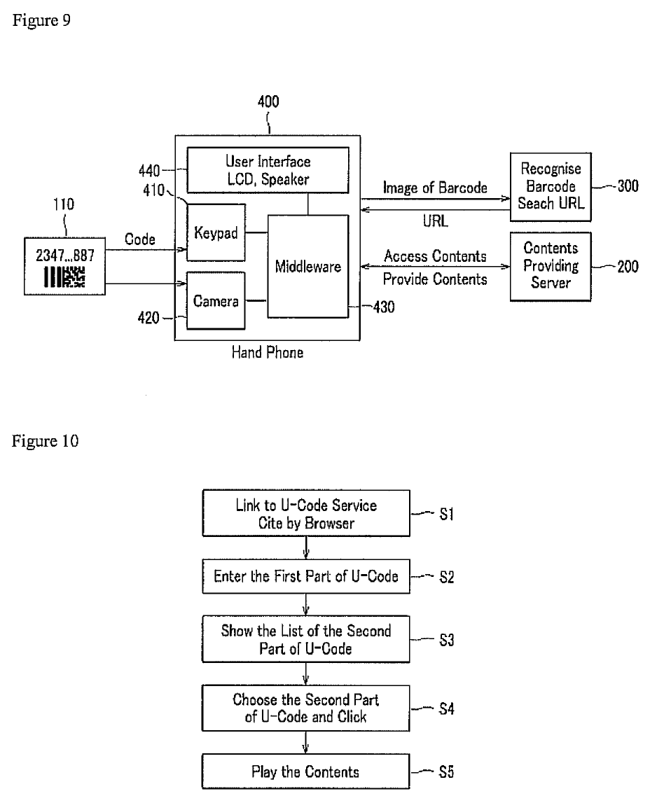

When the user is about to obtain additional content, input the simple code through a user terminal unit, and a user terminal unit can send this simple code to the relay service system. The relay service system can search the URL from the database (DB) and send the relevant URL to a user terminal unit. User terminal unit, which received the URL, can call the content from the content providing server and replay the content. The interfacing service of offline and online content operates by separating the service provider and the content provider or by separating content providers. On the other hand, the interfacing service of offline and online content can be used in the mobile phone and PC. FIG. 9 explains the concept diagram of applying this service to a mobile phone and FIG. 10 explains the process of using the simple code in the PC.

The method of applying the interfacing service of offline and online content to die mobile phone is explained in FIG. 9. When the user needs to use the simple code while reading a magazine, it moves to the simple code menu of a cell phone. Then, input the 1^{st} code into the keypad and enter it. In the case of a simple code serviced cell phone with a camera, the 1^{st} code made of a bar code can be shot by the camera. Input the 2^{nd} code through a keypad and enter it. A mobile phone providing a simple code service should be inputted in a middleware and be linked to a simple code site address.

The middleware of a cell phone should send the 1^{st} and the 2^{nd} code to the relay service system and the relay service system should receive the simple code and search the DB and send the required URL to die cell phone. The simple code in a type of a bar code should send the image of a bar code and interpret the image in the relay service system and search the concerning URL.

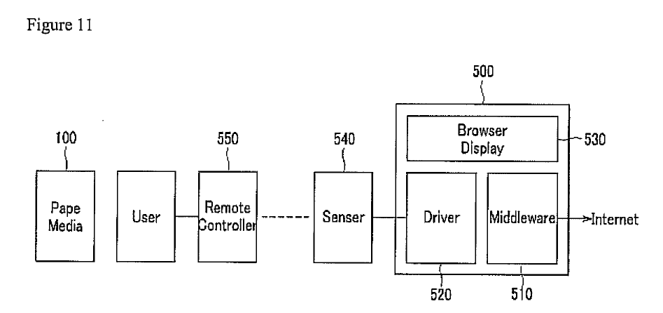

The middleware of a cell phone can receive the URL of the required content from the relay service system. And by using the URL, call the content in the content provider, and reply the content through the interface devices. If the cell phone is not installed with additional middleware, gain access to the simple code site via cell phone and input the simple code and use the simple code service. The advantage of this simple code service is that the service can be used without modifying the middleware, so this service can be applied to all cell phones, PDA, and PMP without having installed cameras. True, in order to use the simple code of a cell phone, the 1^{st} code list should be stored and searched, and input the 2^{nd} code in the keypad to call up the relevant content. The interfacing service of offline and online content in the PC is shown, see FIG. 10. I In FIG. 10, the PC connected to the Internet is less portable than the cell phone, and inconvenient to shoot the bar code type simple code. Therefore, it is convenient to use the browser. In order for the user to use the simple code service, install the website for simple code relay service, log on to the simple code website via user browser and input the simple code. Then, the list of the 2^{nd} code can be shown on the Internet, and if the user clicks the website, it can be automatically connected to the relevant URL. In an attempt to explain the process, the user can call the simple code website within the relay service system via browser and input the 1^{st} code via the simple code website. And then, the simple code website can search the database related to the 1^{st} code and show all the 2^{nd} codes in a type of a link on the screen. The user can click the necessary 2^{nd} code through keyboard and mouse to recall the content, and the relevant content can be replayed on the user's PC. When this method is applied, the user can make use of the simple code service without paying the added costs or without modifying.

[3] The interfacing service of offline and online content by a terminal unit and remote controller. If the book using the simple code uses the short movies and voice files as additional content, the user does not need to stand in front of a terminal unit. In this case, the user should easily call the additional content while reading the book in a comfortable way. To this aim, FIG. 11 was devised for the simple code remote control system. This simple code remote control system includes a remote controller, a sensor, a sensor driver, and a middleware program. If the user pushes the key of the remote controller, the PC receives this signal through the sensor and sensor driver. Then, middleware drives a user interface program or own browser and automatically connects to the simple code website, and when the user inputs the simple code to the remote controller, the simple code is entered on the webpage by discriminating the signal of the remote controller.

For the convenience of a user, the simple code can be pre-registered in their own browser via the keyboard, and then their own browser can be registered or the list of the recently-used simple codes can be stored. This can be shown in the user interface menu, so it is needless to input the simple code via remote controller every time.

Through this system, the remote controller makes it easy to integrate the online and offline content by mainly calling and replaying the content on the Internet. When this process is applied to the service providing the children's story, the process is as follows:

First, the publisher should make the voice file into a streaming file and assign the URL and corresponding simple code, and then store it on the content providing server. Second, input the 1^{st} code, 2^{nd} code and the relevant URL on the relay service system. And then, print the simple code on the cover and the last page of the fairy tale story book and attach the simple code service manual on the book. The user should open the fairy tale story book and push power on the remote control to operate the simple code relay service system inside their own content terminal unit. And then, input the simple code via the remote controller number keypad and enter it. The relay service system, which received the simple code, should realize the 1^{st} code list on the list of the 1^{st} code. The user should select the relevant 2^{nd} code by using the 2^{nd} code and the cursor keys, and push the enter key and operate the program. A user terminal unit should be connected to the URL content and replay the story-telling file. When using the next page, move the key up and down, right and left.

The effects of this invention are as follows:

First, by applying to newspaper, diverse books, additional letters, pictures and short movies can be provided to users on the Internet without using a website.

Second, If we publish only core content and serve the rest of it as multimedia format, we can save the publishing cost. Third, it's possible to do a reading service of books such as a children's book. Fourth, users don't need to link to each site of books. Through a proposed simple code relay service cite, they can access content with a single interface. Fifth, when we use a portable terminal (e.g.; a mobile phone), we can type simple code by keyboard without any redundancy as with a camera. Of course we don't need a barcode print on the book or a barcode reader in the portable terminal.

Sixth, users can order a product in a journal and pamphlet by using our proposed simple code. It means advertisement on the book can be changed as a role of an on-line shopping mall.

While the present invention has been described and illustrated herein with reference to the preferred embodiments thereof, it will be apparent to those skilled in the art that various modifications and variations can be made therein without departing from the sprit and scope of the invention. Thus, it is intended that the present invention covers the modifications and variations of this invention that come within the scope of the appended claims and their equivalents.

1. A method for an Off-line to On-line contents matching service, where with off-line contents a user can easily access the on-line additional contents which is made by a contents provider:
A step for assigning a simple code on the off-line contents for which the user can easily access on-line content;
A step where the contents provider assigns a URL on on-line content for the user to easily access by internet;
A step where the contents provider registers the simple code of off-line contents and the URL of on-line contents on a relay service system;
A step where the relay service system receives simple code from the off-line content user's terminal through the internet;
A step where the relay service system searches the URL corresponding to the simple code and sends that URL to the off-line contents user's terminal equipment;
A step where the offline contents user's terminal equipment accesses corresponding on-line contents by using the URL and plays the corresponding on-line contents.

2. The method according to claim 1, where in the simple code has a layered characteristic of:
A first part of code which represents overall off-line media;
A second part of code which represents each contents which is typed in the off-line media.

3. The method according to claim 2, wherein the first part of the simple code is a title of off-line media (book or newspaper) or combination of numbers and/or letters; the second part of the simple code is a page number or figure number of the off-line media (book or newspaper) or numbers and/or letters.

4. The method according to claim 1, wherein for the off-line to on-line contents matching service method the simple code can be printed by barcode form.

5. The method according to claim 1, wherein the off-line contents user can easily access the on-line additional contents which is prepared by the contents provider. the method further comprising assigning a simple code on the off-line content for which the user can easily access on-line contents and the contents provider assigns a URL on on-line contents, for easily access by internet; and a contents providing server which registers the simple code and URL of on-line contents; user terminal equipment where the user enters the simple code to access an on-line content which is corresponding to the offline contents in the off-line media; the relay service system for is searching the URL corresponding to the simple code and sending that URL to the off-line contents user's terminal equipment.

6. The method according to claim 5, wherein the contents providing server and the relay service system can be installed on a single server and/or operated by the contents provider.

7. The method according to claim 5, wherein the user terminal equipment can be an internet terminal or mobile phone.

8. The method according to claim 7, wherein the mobile phone has an input peripheral where the user can enter the simple code and; middleware which can send the simple code to the relay service system and access the on-line contents by using a URL which is received from die relay service server and replay an accessed content on interface peripherals.

9. The method according to claim 5, wherein the user terminal equipment can be composed of: a remote controller for entering the simple code; a sensor for receiving a control signal of the remote controller; a driver for driving the sensor and; a middleware program which can open the simple code webpage and send the entered simple code by remote controller, access a corresponding URL and also access a corresponding on-line contents and play.
